(19) United States
(12) Patent Application Publication
(10) Pub. No.: US 2013/0209106 A1
(43) Pub. Date: Aug. 15, 2013

(54) OPTICAL TRANSMISSION SYSTEM, MULTI-CORE OPTICAL FIBER, AND METHOD OF MANUFACTURING MULTI-CORE OPTICAL FIBER

(71) Applicant: Furukawa Electric Co., Ltd., (US)

(72) Inventor: Kazunori MUKASA, Tokyo (JP)

(73) Assignee: FURUKAWA ELECTRIC CO., LTD., Tokyo (JP)

(21) Appl. No.: 13/841,818

(22) Filed: Mar. 15, 2013

Related U.S. Application Data
(63) Continuation of application No. PCT/JP12/59111, filed on Apr. 3, 2012.

(30) Foreign Application Priority Data
Apr. 8, 2011 (JP) 2011-086467

(51) Int. Cl. G02B 6/036; H04B 10/2507

(52) U.S. Cl. CPC G02B 6/036; H04B 10/2507
USPC 398/79; 385/126; 65/409

(57) ABSTRACT

An optical transmission system includes: a multi-core optical fiber having a plurality of core portions. Signal light beams having wavelengths different from each other are caused to be input to adjacent core portions of the plurality of core portions. The adjacent core portions are the most adjacent to each other in the multi-core optical fiber.

### CROSS-REFERENCE TO RELATED APPLICATIONS

This application is a continuation of PCT International Application No. PCT/JP2012/059111 filed on Apr. 3, 2012, which claims the benefit of priority from the prior Japanese Patent Application No. 2011-086467 filed on Apr. 8, 2011. The entire contents of the PCT international application and the prior Japanese patent application are incorporated herein by reference.

### BACKGROUND OF THE INVENTION

1. Field of the Disclosure

The present invention relates to an optical transmission system using a multi-core optical fiber and to the multi-core optical fiber, and also to a method of manufacturing the multi-core optical fiber.

2. Description of the Related Art

With the rapid growth of the Internet traffic in recent years, it is expected that transmission capacity will run short with conventional transmission optical fibers. A spatial multiplexing technique using a multi-core optical fiber is regarded as a promising method of solving this shortage of transmission capacity. For example, a seven-core type multi-core optical fiber, which has seven core portions and an effective core area Aeff enlarged to 100 μm² by optimizing its cross-sectional structure, is proposed in non-patent literature by K. Imamura et al. in OFC2010, OWK6 (2010) and non-patent literature by K. Imamura et al. in OECC2010, 7C2-2 (2010). Such enlargement of the effective core area causes optical non-linearity of the optical fiber to be reduced, thereby resulting in a multi-core optical fiber preferable for achieving optical transmission of higher capacity.

Non-patent literature by K. Mukasa et al. in OFC2007, OML1 (2007) discloses that non-linearity of an optical fiber is remarkably suppressed using a photonic band gap fiber (PBGF) and a possibility of achieving long-distance optical transmission with low penalty error by using the photonic band gap fiber.

### SUMMARY

### Technical Problem

There is a need for multi-core optical fibers to have good crosstalk characteristics between core portions so that signal light beams propagating through the core portions are prevented from interfering with one another and deteriorating.

Accordingly, there is a need to provide an optical transmission system and a multi-core optical fiber that achieve good crosstalk characteristics, and a method of manufacturing the multi-core optical fiber.

### SUMMARY OF THE INVENTION

According to an embodiment of the present invention, an optical transmission system includes: a multi-core optical fiber having a plurality of core portions. Signal light beams having wavelengths different from each other are caused to be input to adjacent core portions of the plurality of core portions. The adjacent core portions are the most adjacent to each other in the multi-core optical fiber.

According to another embodiment of the present invention, a multi-core optical fiber includes: a plurality of core portions; and a plurality of holes arranged to form photonic band gaps of band gap wavelength bands different from each other for adjacent core portions adjacent to each other of the plurality of core portions.

According to yet another embodiment of the present invention, a method of manufacturing the multi-core optical fiber includes: forming a plurality of glass preforms including portions to become the core portions and holes for forming the band gap wavelength bands in the core portions by a stack-and-draw method; forming an optical fiber preform by bundling the plurality of glass preforms; and drawing the optical fiber preform to manufacture the multi-core optical fiber.

According to still another embodiment of the present invention, a method of manufacturing the multi-core optical fiber includes: forming an optical fiber preform including portions to become the plurality of core portions and holes for forming the band gap wavelength bands in the core portions by a stack-and-draw method; and drawing the optical fiber preform to manufacture the multi-core optical fiber.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a block structural diagram of an optical transmission system according to a first embodiment.

FIG. 2 is a block structural diagram of an optical transmission system according to a second embodiment.

FIG. 3 is a block structural diagram of an optical transmission system according to a third embodiment.

FIG. 4 is a block structural diagram of an optical transmission system according to a fourth embodiment.

FIG. 5 is a block structural diagram of an optical transmission system according to a fifth embodiment.

FIG. 6 is a schematic cross-sectional view of a multi-core optical fiber of a holey fiber type.

FIG. 7 is a schematic cross-sectional view of a multi-core optical fiber of a photonic band gap type used in an optical transmission system according to a sixth embodiment.

FIG. 8 is a block structural diagram of the optical transmission system according to the sixth embodiment.

FIG. 9 is a schematic diagram illustrating band gap wavelength bands of the multi-core optical fiber illustrated in FIG. 8.

FIG. 10 is a schematic diagram illustrating an example of a confinement loss spectrum of a multi-core optical fiber of a photonic band gap type.

FIG. 11 is a block structural diagram of an optical transmission system according to a seventh embodiment.

FIG. 12 is a schematic diagram illustrating a confinement loss spectrum of a multi-core optical fiber illustrated in FIG. 11.

FIG. 13 is a block structural diagram of an optical transmission system according to an eighth embodiment.

FIG. 14 is a block structural diagram of an optical transmission system according to a ninth embodiment.

FIG. 15 is a diagram illustrating an example of a method of manufacturing the multi-core optical fiber of the photonic band gap type illustrated in FIG. 7.

### DETAILED DESCRIPTION OF THE INVENTION

When signal light beams having the same wavelength of 1550 nm are input to and transmitted through core portions that are the most adjacent to each other in a multi-core optical fiber, after transmission of 100 km in the multi-core optical fiber, an optical power having a level of approximately −30 dB with respect to a power of signal light ends up being transferred to the adjacent core portion by crosstalk, for example. Light having a power of −30 dB causes a large noise in the core portion to which the light has been transferred, thereby causing transmission characteristics of that core portion to deteriorate.

In contrast, in the present invention, signal light beams having different wavelengths from each other are input to core portions that are the most adjacent to each other in a multi-core optical fiber. This enables influence of crosstalk on the adjacent core portion to be remarkably suppressed, thereby achieving good crosstalk characteristics.

Embodiments of an optical transmission system, a multi-core optical fiber, and a method of manufacturing the multi-core optical fiber according to the present invention are described in detail below with reference to the accompanying drawings. The embodiments do not limit the present invention.

### First Embodiment

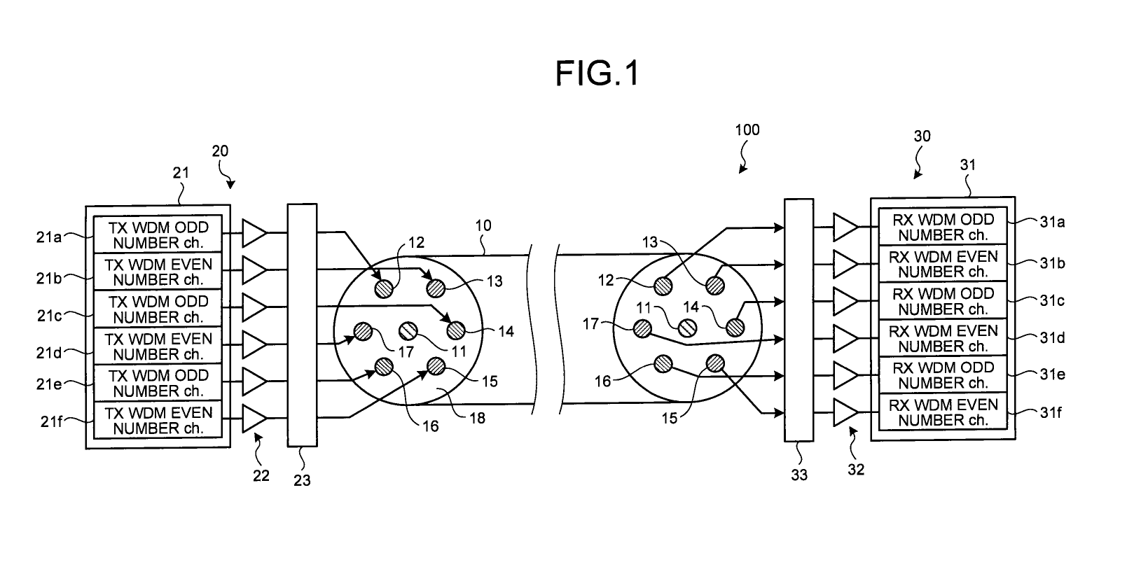

As an embodiment of the present invention, an optical transmission system to which an optical transmission system according to the present invention is applied is described. FIG. 1 is a block structural diagram of an optical transmission system according to a first embodiment. As illustrated in FIG. 1, an optical transmission system 100 includes a multi-core optical fiber 10, and a transmission device 20 and a receiving device 30 that are connected by the multi-core optical fiber 10.

The multi-core optical fiber 10 includes core portions 11 to 17 made of silica based glass and a cladding portion 18 that is made of silica based glass, formed around the core portions 11 to 17, and has a lower refractive index than those of the core portions 11 to 17. The multi-core optical fiber 10, which has a solid structure with no holey structure in the core portions 11 to 17 and the cladding portion 18, is a so-called solid type multi-core optical fiber. The core portion 11 is positioned near the center of a longitudinal axis of the multi-core optical fiber 10 while the other core portions 12 to 17 are arranged at respective vertices of a regular hexagon whose center of gravity is at the core portion 11. The core portions 11 to 17 have approximately the same core diameter, e.g., 8 μm. Relative refractive-index differences of the core portions 11 to 17 to the cladding portion 18 are approximately the same, e.g., 0.35%. The core diameter and the relative refractive-index difference are not limited to these values.

The transmission device 20 includes an optical transmission unit 21 having transmitters (Tx) 21a to 21f each including a light source such as a semiconductor laser, a plurality of optical amplifiers 22 connected to the transmitters 21a to 21f, and an optical connector 23 connected to the plurality of optical amplifiers 22.

The optical transmission unit 21 outputs wavelength division multiplexing (WDM) signal light. The WDM signal light is composed of a plurality of signal light beams corresponding to signal channels allocated to a wavelength grid specified by the ITU-T (International Telecommunication Union), for example. The transmitters 21a, 21c, and 21e are configured to output signal light beams of odd-numbered channels, when channel numbers are allocated to a plurality of signal channels composing the WDM signal light in ascending or descending order of wavelength. The transmitters 21b, 21d, and 21f are configured to output signal light beams of even-numbered channels composing the WDM signal light. The number of signal light beams output by each of the transmitters 21a to 21f may be one or more of the odd-numbered or even-numbered channels.

The plurality of optical amplifiers 22, which are optical fiber amplifiers or semiconductor optical amplifiers provided as many as the number corresponding to the number of the transmitters 21a to 21f, for example, amplify the signal light beams output by the transmitters 21a to 21f. The optical connector 23 is configured to cause the signal light beams output from the transmitters 21a, 21b, 21c, 21d, 21e, and 21f and amplified, to be input to the core portions 12, 13, 14, 17, 16, and 15 of the multi-core optical fiber 10, respectively. The optical connector 23 may be realized by an optical fiber bundle formed by bundling optical fibers as disclosed in Japanese Patent Application Laid-open No. 2010-237457, for example.

The receiving device 30 includes an optical receiving unit 31 including receivers (Rx) 31a to 31f each having a light receiver such as a photo diode, a plurality of optical amplifiers 32 connected to the receivers 31a to 31f, and an optical connector 33 connected to the plurality of optical amplifiers 32. The plurality of optical amplifiers 32 are provided as many as the number corresponding to the number of the receivers 31a to 31f.

The optical connector 33 is configured to cause the signal light beams output from the core portions 12, 13, 14, 17, 16, and 15 of the multi-core optical fiber 10 and amplified by the plurality of optical amplifiers 32, to be input to the receivers 31a, 31b, 31c, 31d, 31e, and 31f, respectively. The optical connector 33 may also be implemented by a known optical fiber bundle.

The receivers 31a, 31b, 31c, 31d, 31e, and 31f are configured to receive the signal light beams transmitted from the transmitters 21a, 21b, 21c, 21d, 21e, and 21f through the multi-core optical fiber 10, and to convert them into electrical signals.

In the optical transmission system 100, the transmission device 20 inputs the signal light beams having different wavelengths from each other to core portions that are the most adjacent to each other in the multi-core optical fiber 10, e.g., the core portion 13 or the core portion 17 for the core portion 12. The multi-core optical fiber 10 transmits input signal light beams through the respective core portions 12 to 17. The receiving device 30 receives the signal light beams transmitted through the respective core portions 12 to 17 by the receivers 31a, 31b, 31c, 31d, 31e, and 31f and converts them into electrical signals.

As described above, in the optical transmission system 100, the signal light beam of the odd-numbered channel is input to the core portion 12 while the signal light beam of the even-numbered channel is input to the core portion 13 or the core portion 17, for example. As a result, even if a power of the signal light beam of the even-numbered channel transmitted through the core portion 13 or the core portion 17 is transferred to the core portion 12, for example, because their wavelengths differ from each other, interference of the transferred signal light beam with the signal light beam of the odd-numbered channel transmitted through the core portion 12 is mostly suppressed. Also in the other core portions 13 to 17, the interference between the signal light beam transmitted through the core portion and the signal light beam transferred from the other core portion is mostly suppressed. In addition, as the difference in wavelengths of the signal light beam transmitted through the core portion and signal light beam transferred from the other core portion increases, non-linear interference such as cross-phase modulation is also further suppressed. Therefore, the optical transmission system 100 according to the first embodiment has good crosstalk characteristics, and is suitable for long-distance optical transmission with small penalty error, for example.

Although the core portion 11 dose not transmit signal light in the first embodiment, signal light may be transmitted using the core portion 11 as in the embodiments described later. Further, the core portion 11 may be used for optical axis alignment upon connection between the multi-core optical fibers 10 or between the multi-core optical fiber 10 and the transmission device 20 or the receiving device 30. In the first embodiment, the multi-core optical fiber 10 may be replaced with a multi-core optical fiber having a configuration like the multi-core optical fiber 10 but without the core portion 11.

### Second Embodiment

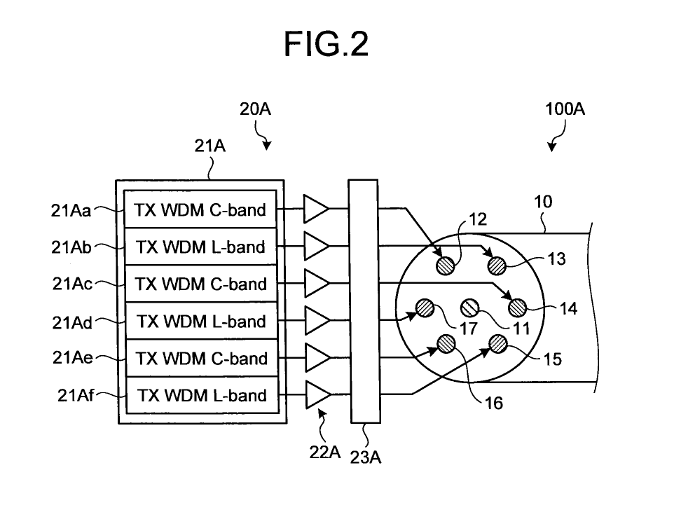

FIG. 2 is a block structural diagram of an optical transmission system according to a second embodiment. As illustrated in FIG. 2, in an optical transmission system 100A, the transmission device 20 is replaced with a transmission device 20A and the receiving device 30 is replaced with a receiving device (not illustrated) in the optical transmission system 100.

The transmission device 20A includes an optical transmission unit 21A including transmitters (Tx) 21Aa to 21Af, a plurality of optical amplifiers 22A connected to the transmitters 21Aa to 21Af, and an optical connector 23A connected to the plurality of optical amplifiers 22A.

The optical transmission unit 21A outputs WDM signal light of C band (approximately 1530 nm to 1565 nm) and L band (approximately 1565 nm to 1625 nm), which are wavelength bands used in optical communications. The transmitters 21Aa, 21Ac, and 21Ae are configured to output the WDM signal light of the C band. The transmitters 21Ab, 21Ad, and 21Af are configured to output the WDM signal light of the L band.

The optical amplifiers 22A amplify the signal light beams output by the transmitters 21Aa to 21Af. The optical connector 23A is configured to cause the signal light beams output from the respective transmitters 21Aa, 21Ab, 21Ac, 21Ad, 21Ae, and 21Af and amplified to be input to the core portions 12, 13, 14, 17, 16, and 15 of the multi-core optical fiber 10, respectively.

The receiving device not illustrated has a configuration in which the respective receivers of the optical receiving unit 31 in the receiving device 30 illustrated in FIG. 1 are replaced with the receivers that are able to receive the WDM signal light of the C band or the L band transmitted from the transmitters 21Aa, 21Ab, 21Ac, 21Ad, 21Ae, and 21Af.

Also in the optical transmission system 100A, the transmission device 20A inputs the signal light beams having different wavelength bands from each other to core portions that are the most adjacent to each other in the multi-core optical fiber 10, e.g., the core portion 13 or the core portion 17 for the core portion 12. Accordingly, because the signal light beams having different wavelength bands are input to the core portions adjacent to each other, interference between the signal light beam transmitted in each of the core portions 12 to 17 and the signal light beam transferred from the other core portion is further suppressed. In addition, non-linear interference such as cross-phase modulation is also further suppressed. Therefore, the optical transmission system 100A according to the second embodiment has better crosstalk characteristics.

Although the core portion 11 dose not transmit signal light in the second embodiment, signal light may be transmitted using the core portion 11 as in the embodiments described later. The core portion 11 may be used for optical axis alignment upon connection between the multi-core optical fibers 10 or between the multi-core optical fiber 10 and the transmission device 20 or the receiving device 30. Further, in the second embodiment, the multi-core optical fiber 10 may be replaced with a multi-core optical fiber having a configuration like the multi-core optical fiber 10 without the core portion 11.

### Third Embodiment

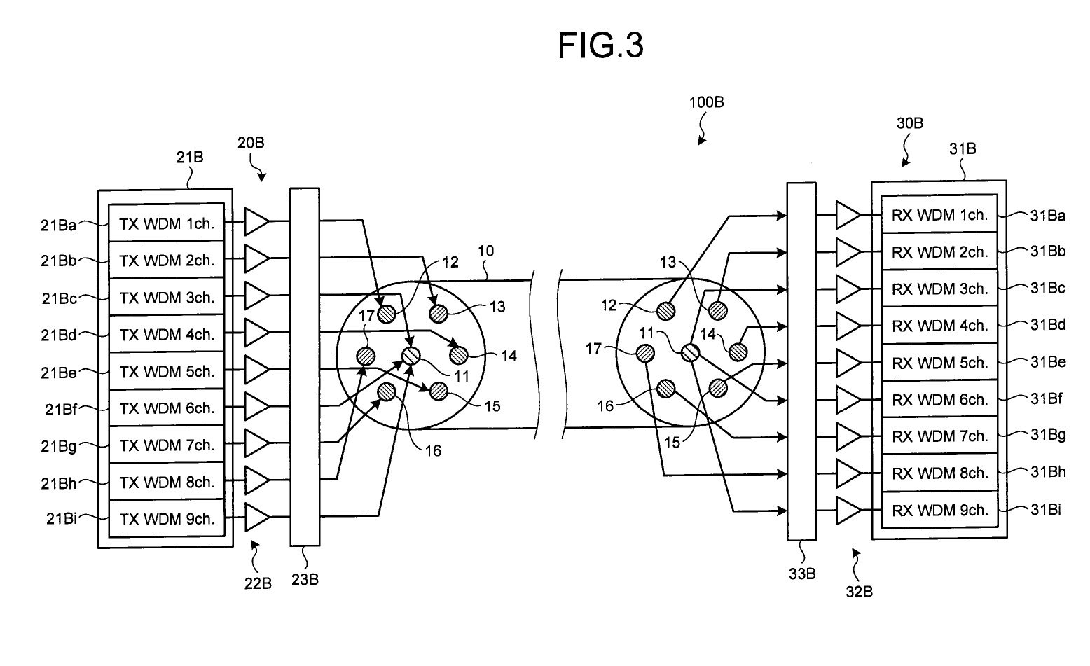

FIG. 3 is a block structural diagram of an optical transmission system according to a third embodiment. As illustrated in FIG. 3, in an optical transmission system 100B, the transmission device 20 is replaced with a transmission device 20B and the receiving device 30 is replaced with a receiving device 30B in the optical transmission system 100.

The transmission device 20B includes an optical transmission unit 21B including transmitters (Tx) 21Ba to 21Bi, a plurality of optical amplifiers 22B connected to the transmitters 21Ba to 21Bi, and an optical connector 23B connected to the plurality of optical amplifiers 22B.

The transmitters 21Ba to 21Bi are configured to output signal light beams of channel 1 to channel 9 respectively when channel numbers are allocated to a plurality of signal channels composing WDM signal light in ascending or descending order.

The plurality of optical amplifiers 22B are provided as many as the number corresponding to the number of transmitters 21Ba to 21Bi and amplify the signal light beams output by the transmitters 21Ba to 21Bi. The optical connector 23B is configured to cause the signal light beams output from the respective transmitters 21Ba, 21Bb, 21Bc, 21Bd, 21Be, 21Bf, 21Bg, 21Bh, and 21Bi and amplified to be input to the core portions 12, 13, 11, 14, 15, 11, 16, 17, and 11 of the multi-core optical fiber 10, respectively.

The receiving device 30B includes an optical receiving unit 31B including receivers (Rx) 31Ba to 31Bi, a plurality of optical amplifiers 32B connected to the receivers 31Ba to 31Bi, and an optical connector 33B connected to the plurality of optical amplifiers 32B. The plurality of optical amplifiers 32B are provided as many as the number corresponding to the number of receivers 31Ba to 31Bi.

The optical connector 33B is configured to cause the signal light beams output from the core portions 12, 13, 14, 15, 16, and 17 of the multi-core optical fiber 10 and amplified to be input to the respective receivers 31Ba, 31Bb, 31Bd, 3Be, 31Bg, and 31Bh, and the signal beams output from the core portion 11 and amplified to be input to the respective receivers 31Bc, 31Bf, and 31Bi.

The receivers 31Ba, 31Bb, 31Bc, 31Bd, 31Be, 31Bf, 31Bg, 31Bh, and 31Bi are configured to receive the signal light beams transmitted from the transmitters 21Ba, 21Bb, 21Bc, 21Bd, 21Be, 21Bf, 21Bg, 21Bh, and 21Bi through the multi-core optical fiber 10, and to convert them into electrical signals.

The core portions 11 to 17 are classified into a first core group composed of the core portions 12, 14, and 16, which are arranged in a triangle shape and are not the most adjacent to each other, a second core group composed of the core portions 13, 15, and 17, which are arranged in an inverted-triangle shape and are not the most adjacent to each other, and a third core group composed of the core portion 11 positioned near the center.

In the optical transmission system 100B, the signal light beams of channel 1, channel 2, . . . , and channel 9 output from the transmitters 21Ba to 21Bi are allocated in order and input to the first core group, the second core group, the third core group, the first core group, . . . , and the third core group. This enables the signal light beams having different wavelengths from each other to be input to the core portions the most adjacent to each other with a larger wavelength difference therebetween using all of the seven core portions 11 to 17. Consequently, in the optical transmission system 100B, optical transmission with higher-capacity and good crosstalk characteristics is achievable.

Although, in the third embodiment, the signal light beams of channel 1 and channel 4, which have different wavelengths from each other, are input respectively to non-adjacent core portions, e.g., the core portion 12 and the core portion 14, the present invention is not limited thereto, and signal light beams having the same wavelength (or the same wavelength band) may be input to the core portions as long as they are not adjacent to each other.

### Fourth Embodiment

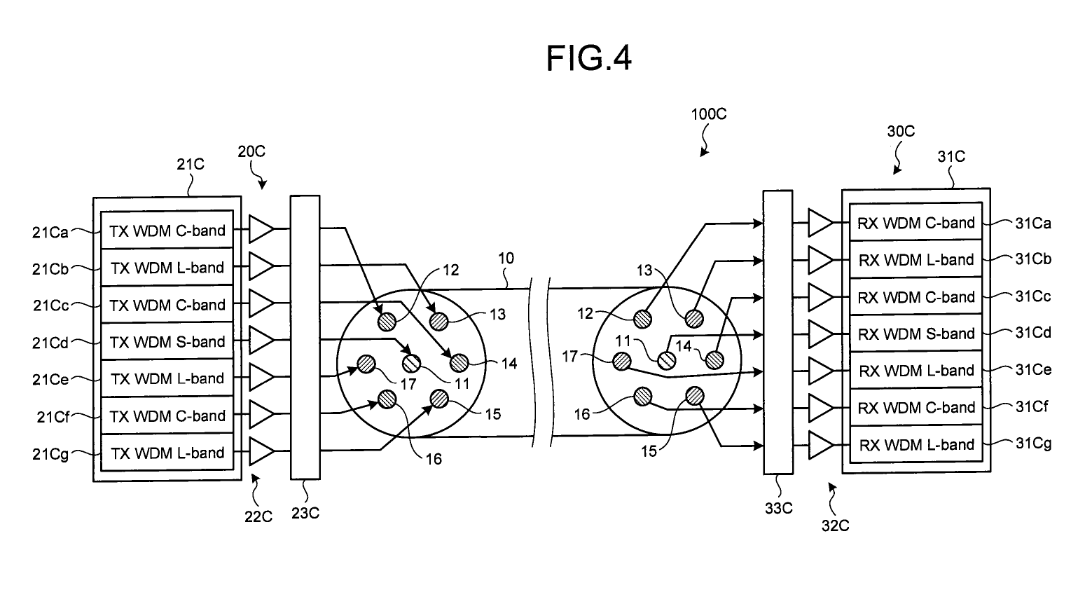

FIG. 4 is a block structural diagram of an optical transmission system according to a fourth embodiment. As illustrated in FIG. 4, in an optical transmission system 100C, the transmission device 20 is replaced with a transmission device 200 and the receiving device 30 is replaced with a receiving device 30C in the optical transmission system 100.

The transmission device 20C includes an optical transmission unit 21C including transmitters (Tx) 21Ca to 21Cg, a plurality of optical amplifiers 22C connected to the transmitters 21Ca to 21Cg, and an optical connector 23C connected to the plurality of optical amplifiers 22C.

The optical transmission unit 21C outputs WDM signal light of an S band (approximately 1460 nm to 1530 nm), the C band, and the L band, which are the wavelength bands used in optical communications. The transmitters 21Ca, 21Cc, and 21Cf are configured to output the WDM signal light of the C band. The transmitters 21Cb, 21Ce, and 21Cg are configured to output the WDM signal light of the L band. The transmitter 21Cd is configured to output the WDM signal light of the S band.

The plurality of optical amplifiers 22C are provided as many as the number corresponding to the number of transmitters 21Ca to 21Cg and amplify signal light beams output by the transmitters 21Ca to 21Cg. The optical connector 23C is configured to cause the signal light beams output from the respective transmitters 21Ca, 21Cb, 21Cc, 21Cd, 21Ce, 21Cf, and 21Cg and amplified to be input to the core portions 12, 13, 14, 11, 17, 16, and 15 of the multi-core optical fiber 10, respectively.

The receiving device 30C includes an optical receiving unit 31C including receivers (Rx) 31Ca to 31Cg, a plurality of optical amplifiers 32C connected to the receivers 31Ca to 31Cg, and an optical connector 33C connected to the optical amplifiers 32C. The plurality of optical amplifiers 32C are provided as many as the number corresponding to the number of receivers 31Ca to 31Cg.

The optical connector 33C is configured to cause signal light beams output from the core portions 12, 13, 14, 11, 17, 16, and 15 of the multi-core optical fiber 10 and amplified to be input to the receivers 31Ca, 31Cb, 31Cc, 31Cd, 31Ce, 31Cf, and 31Cg, respectively.

The receivers 31Ca, 31Cb, 31Cc, 31Cd, 31Ce, 31Cf, and 31Cg are configured to receive the signal light beams transmitted from the transmitters 21Ca, 21Cb, 21Cc, 21Cd, 21Ce, 21Cf, and 21Cg through the multi-core optical fiber 10, and to convert them into electrical signals.

The core portions 11 to 17 are classified into the first core group composed of the core portions 12, 14, and 16, the second core group composed of the core portions 13, 15, and 17, and the third core group including the core portion 11 in the same manner as the third embodiment.

In the optical transmission system 100C, the signal light beams of the C band, the L band, and the S band output from the optical transmission unit 21C are allocated and input to the first core group, the second core group, and the third core group, respectively. This enables the signal light beams having different wavelength bands from each other to be input to the core portions the most adjacent to each other using all of the seven core portions 11 to 17. Consequently, in the optical transmission system 100C, optical transmission with high capacity and good crosstalk characteristics is achievable. Moreover, in the optical transmission system 100C, by allocating the C band and the L band, which have transmission capacities that are easy to be increased due to a reason such as a lower transmission loss than the S band, to the first or the third core group having many core portions, the core portions are able to be used more efficiently.

### Fifth Embodiment

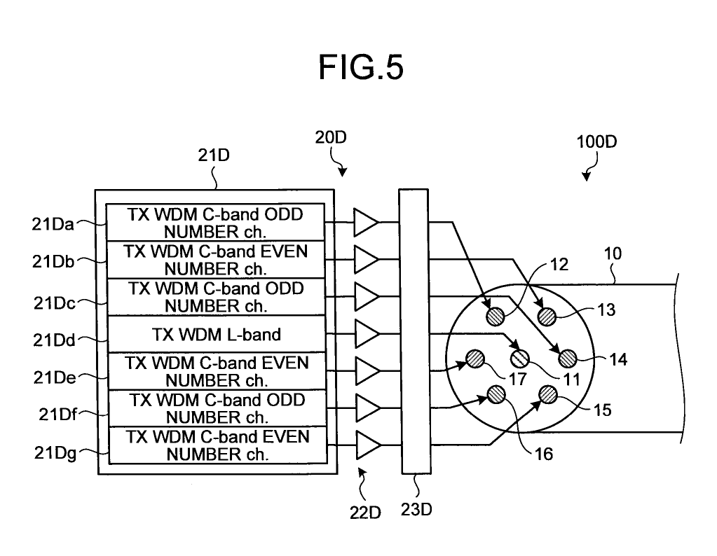

FIG. 5 is a block structural diagram of an optical transmission system according to a fifth embodiment. As illustrated in FIG. 5, in an optical transmission system 100D, the transmission device 20 is replaced with a transmission device 20D and the receiving device 30 is replaced with a receiving device (not illustrated) in the optical transmission system 100.

The transmission device 20D includes an optical transmission unit 21D including transmitters (Tx) 21Da to 21Dg, a plurality of optical amplifiers 22D connected to the transmitters 21Da to 21Dg, and an optical connector 23D connected to the plurality of optical amplifiers 22D.

The transmitters 21Da, 21Dc, and 21Df in the optical transmission unit 21D are configured to output the signal light beams of odd-numbered channels of WDM signal light of the C band. The transmitters 21Db, 21De, and 21Dg are configured to output the signal light beams of even-numbered channels of WDM signal light of the C band. The transmitter 21Dd is configured to output WDM signal light of the L band.

The plurality of optical amplifiers 22D amplify the signal light beams output by the transmitters 21Da to 21Dg. The optical connector 23D is configured to cause the signal light beams output from the respective transmitters 21Da, 21Db, 21Dc, 21Dd, 21De, 21Df, and 21Dg and amplified to be input to the core portions 12, 13, 14, 11, 17, 16, and 15 of the multi-core optical fiber 10, respectively.

The receiving device not illustrated has a configuration in which the respective receivers of the optical receiving unit 31 in the receiving device 30 illustrated in FIG. 1 are replaced with receivers that are able to receive WDM signal light of the C band or the L band transmitted from the transmitters 21Da to 21Dg.

In the optical transmission system 100D, the signal light beams of the odd-numbered channels of the C band and the even-numbered channels of the C band, and of the L band output from the optical transmission unit 21D are allocated and input to the first core group, the second core group, and the third core group, respectively. This enables the signal light beams having different wavelength bands from each other or a large wavelength difference therebetween to be input to the core portions the most adjacent to each other using all of the seven core portions 11 to 17. Consequently, in the optical transmission system 100D, optical transmission with larger capacity and good crosstalk characteristics is achievable. In the optical transmission system 100D, the signal light of the L band having a higher bending loss than the C band is allocated to the core portion 11 positioned near the center of the multi-core optical fiber 10. Accordingly, the signal light of the L band becomes hard to be influenced by bending of the multi-core optical fiber 10 and thus a low bending loss is achievable even when any of the core portions of the multi-core optical fiber 10 is used.

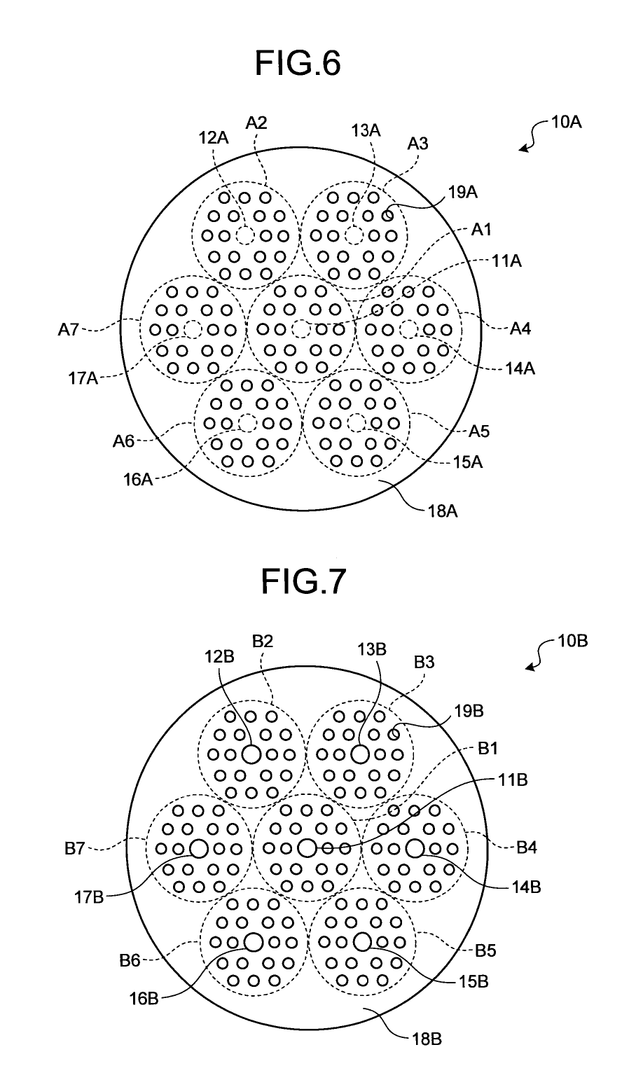

Although the multi-core optical fiber 10 is of a solid type in the above embodiments, a multi-core optical fiber of a holey fiber type may be used. FIG. 6 is a schematic cross-sectional view of a multi-core optical fiber of the holey fiber type. As illustrated in FIG. 6, a multi-core optical fiber 10A of the holey fiber type includes core portions 11A to 17A and a cladding portion 18A formed around the core portions. The core portion 11A is positioned near the center of the longitudinal axis of the multi-core optical fiber 10A while the other core portions 12A to 17A are arranged at respective vertices of a regular hexagon having a center of gravity at the core portion 11A. The core portions 11A to 17A and the cladding portion 18A are made of silica based glass having equal refractive indices. The cladding portion 18A has a plurality of holes 19A formed in regions A1 to A7 respectively including the core portions 11A to 17A. The holes 19A are arranged in a triangle lattice shape. Assuming that a lattice constant of this triangle lattice (i.e., a distance between holes) is Λ and a hole diameter is d, optical characteristics of the respective core portions 11A to 17A are able to be set by: d/Λ and Λ in the respective areas A1 to A7; and the number of hexagonal layers (holey layers) formed by the holes 19A to surround the respective core portions 11A to 17A. For example, d/Λ is 0.43, Λ is 7 μm, and the number of holey layers is 5, but limitation is not made thereto.

### Sixth Embodiment

Next, an optical transmission system using a multi-core optical fiber of a photonic band gap fiber type according to a sixth embodiment is described. FIG. 7 is a schematic cross-sectional view of a multi-core optical fiber of the photonic band gap type used in the optical transmission system according to the sixth embodiment.

As illustrated in FIG. 7, a multi-core optical fiber 10B of the photonic band gap type includes core portions 11B to 17B having a holey structure and a cladding portion 18B formed around the core portions. That is, the multi-core optical fiber 10B is a so-called air-core type photonic band gap fiber.

The core portion 11B is positioned near the center of the longitudinal axis of the multi-core optical fiber 10B while the other core portions 12B to 17B are arranged at respective vertices of a regular hexagon whose center of gravity is at the core portion 11B. The core portions 11B to 17B and the cladding portion 18B are made of silica based glass having equal refractive indices. The cladding portion 18B has a plurality of holes 19B formed in each of regions B1 to B7 including the respective core portions 11B to 17B.

The holes 19B arranged in each of the regions B1 to B7 are arranged in a triangle lattice shape so as to form a photonic crystal, and a photonic band gap is formed due to a two-dimensional Bragg reflection at a wavelength of light to be transmitted. As a result, the core portions 11B to 17B introduced in the respective areas B1 to B7 as crystal defects are each able to transmit only light of a band gap wavelength band including a wavelength of the light to be transmitted. Assuming that a lattice constant of the triangular lattice (i.e., the distance between holes) is Λ and a hole diameter is d, the band gap wavelength band of each of the core portions 11B to 17B is able to be set by d/Λ and Λ.

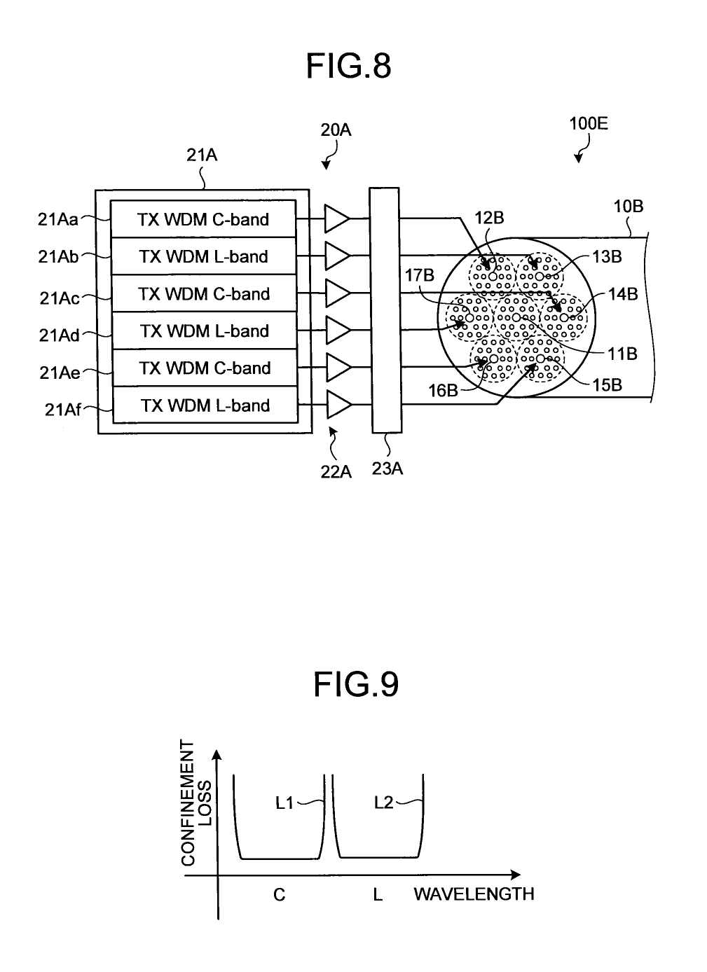

FIG. 8 is a block structural diagram of an optical transmission system according to the sixth embodiment. As illustrated in FIG. 8, an optical transmission system 100E includes the multi-core optical fiber 10B illustrated in FIG. 7, and the transmission device 20A and the not-illustrated receiving device of the second embodiment illustrated in FIG. 2.

The optical connector 23A is configured to cause the signal light beams output from the respective transmitters 21Aa, 21Ab, 21Ac, 21Ad, 21Ae, and 21Af and amplified to be input to the core portions 12B, 13B, 14B, 17B, 16B, and 15B of the multi-core optical fiber 10B, respectively.

FIG. 9 is a schematic diagram illustrating band gap wavelength bands of the multi-core optical fiber 10B illustrated in FIG. 8. The horizontal axis represents wavelength while the vertical axis represents confinement loss. As illustrated in FIG. 9, the band gap wavelength band indicated with a line L1 is set so as to correspond to the C band in the core portions 12B, 14B, and 16B, which are not the most adjacent to each other and to which the WDM signal light of the C band output from the transmitters 21Aa, 21Ac, and 21Ae is input. In addition, the band gap wavelength band indicated with a line L2 is set so as to correspond to the L band in the core portions 13B, 15B, and 17B, which are not the most adjacent to each other and to which the WDM signal light of the L band output from the transmitters 21Ab, 21Ad, and 21Af is input.

As described, in the optical transmission system 100E, different band gap wavelength bands are set in the core portions adjacent to each other in the multi-core optical fiber 10B. As a result, even when signal light is transferred to the core portion 12B from the most adjacent core portion 13B, for example, the transferred signal light is not transmitted through the core portion 12B, and thus interference between the signal light beams are further suppressed. Therefore, the optical transmission system 100E according to the sixth embodiment has even better crosstalk characteristics.

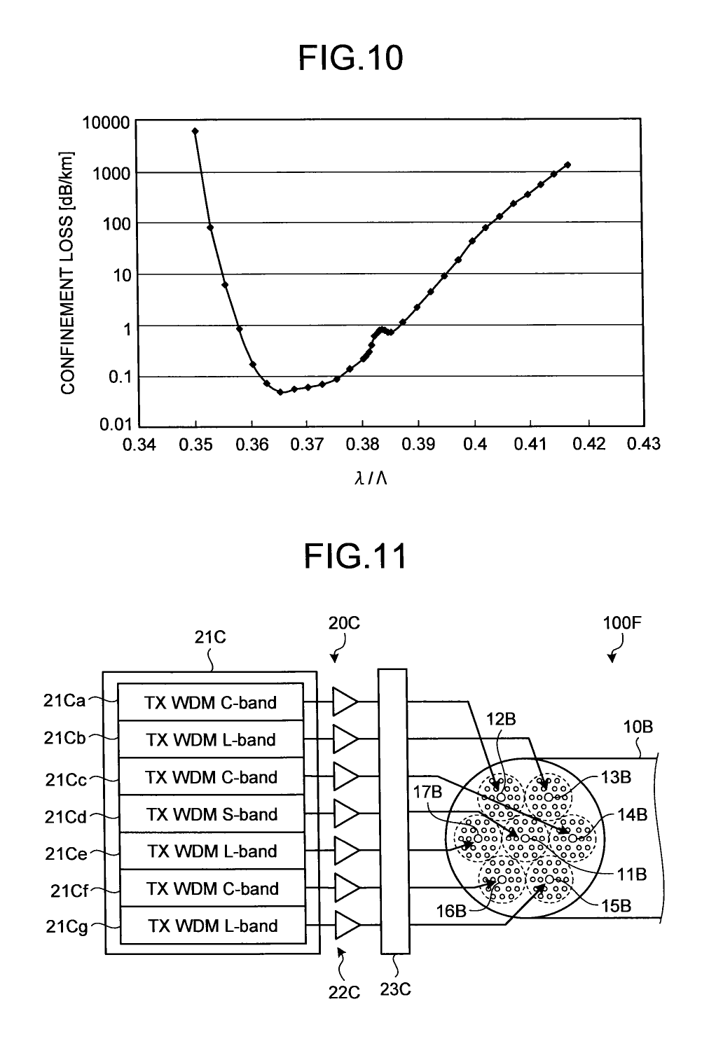

FIG. 10 is a diagram illustrating an example of a confinement loss spectrum of a multi-core optical fiber of the photonic band gap type. The horizontal axis represents a ratio of an arbitrary wavelength λ to a distance between holes Λ while the vertical axis represents calculated value of confinement loss with respect to λ/Λ when d/Λ is set to 0.97 (see non-patent literature by K. Saitoh, et al. in OPTICS EXPRESS, Vol. 11, No. 23, 2003, pp 3100-3109). In FIG. 10, a band gap wavelength band is formed in which the confinement loss becomes minimum when λ/Λ is approximately 0.37. Accordingly, if a band gap wavelength band in which the confinement loss becomes minimum at a wavelength of approximately 1.55 μm is to be formed, Λ may be set to approximately 1.55/0.37=4.19 μm.

Although the core portion 11B does not transmit signal light in the sixth embodiment, signal light may be transmitted using the core portion 11B as in the embodiments described later. The core portion 11B may be used for optical axis alignment upon connection between the multi-core optical fibers 10B or between the multi-core optical fiber 10B and the transmission device 20A or the receiving device. Further, in the sixth embodiment, the multi-core optical fiber 10B may be replaced with a multi-core optical fiber having a configuration like the multi-core optical fiber 10B without the core portion 11B.

### Seventh Embodiment

FIG. 11 is a block structural diagram of an optical transmission system according to a seventh embodiment. As illustrated in FIG. 11, an optical transmission system 100F includes the multi-core optical fiber 10B, and the transmission device 20C and the not-illustrated receiving device of the fourth embodiment illustrated in FIG. 4.

The optical connector 23C is configured to cause the signal light beams output from the respective transmitters 21Ca, 21Cb, 21Cc, 21Cd, 21Ce, 21Cf, and 21Cg and amplified to be input to the core portions 12B, 13B, 14B, 11B, 17B, 16B, and 15B of the multi-core optical fiber 10B, respectively.

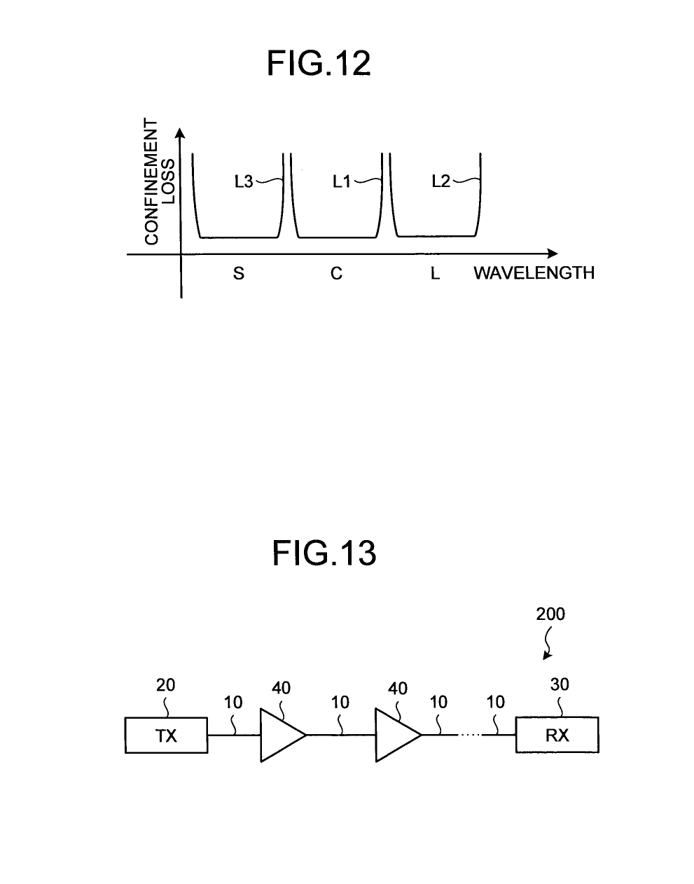

FIG. 12 is a schematic diagram illustrating band gap wavelength bands of the multi-core optical fiber 10B illustrated in FIG. 11. The horizontal axis represents wavelength while the vertical axis represents confinement loss. As illustrated in FIG. 12, a band gap wavelength band indicated with a line L1 is set so as to correspond to the C band in the core portions 12B, 14B, and 16B, which are not the most adjacent to each other and to which the WDM signal light of the C band output from the transmitters 21Ca, 21Cc, and 21Cf is input. In addition, a band gap wavelength band indicated with a line L2 is set so as to correspond to the L band in the core portions 13B, 15B, and 17B, which are not the most adjacent to each other and to which the WDM signal light of the L band output from the transmitters 21Cb, 21Ce, and 21Cg is input. Furthermore, a band gap wavelength band indicated with a line L3 is set so as to correspond to the S band in the core portion 11B to which the WDM signal light of the S band output from the transmitter 21Cd is input.

As described, in the optical transmission system 100F, different band gap wavelength bands are set in the core portions adjacent to each other in the multi-core optical fiber 10B. As a result, even when a signal light beam is transferred to the core portion 12B from the most adjacent core portion 13B, for example, the transferred signal light beam is not transmitted through the core portion 12B, resulting in interference between the signal light beams being further suppressed. Therefore, the optical transmission system 100F according to the seventh embodiment has even better crosstalk characteristics.

### Eighth Embodiment

FIG. 13 is a block structural diagram of an optical transmission system according to an eighth embodiment. As illustrated in FIG. 13, an optical transmission system 200 has a configuration in which a plurality of multi-core optical fibers 10 and a plurality of multi-core optical amplifiers 40 are alternately connected between the transmission device 20 and the receiving device 30 illustrated in FIG. 1.

The multi-core optical amplifier 40 optically amplifies signal light transmitted by the multi-core optical fiber 10 and compensates its transmission loss. The multi-core optical amplifier 40, in which an amplifying optical fiber of an optical fiber amplifier such as an erbium-doped optical fiber amplifier or a Raman amplifier is composed of a multi-core optical fiber, may be used. Or, the multi-core optical amplifier 40 may be configured such that signal light beams transmitted through the respective core portions of the multi-core optical fiber 10 are multiplexed by an optical fiber bundle or the like into a single optical fiber, and this is amplified by an optical fiber amplifier using an amplifying optical fiber having a single core portion. Further, the multi-core optical amplifier 40 may be configured of a semiconductor optical amplifier.

The optical transmission system 200 is suitable for achieving longer distance optical transmission because the multi-core optical fibers 10 are cascading-connected by the multi-core optical amplifiers 40 serving as optical repeaters.

### Ninth Embodiment

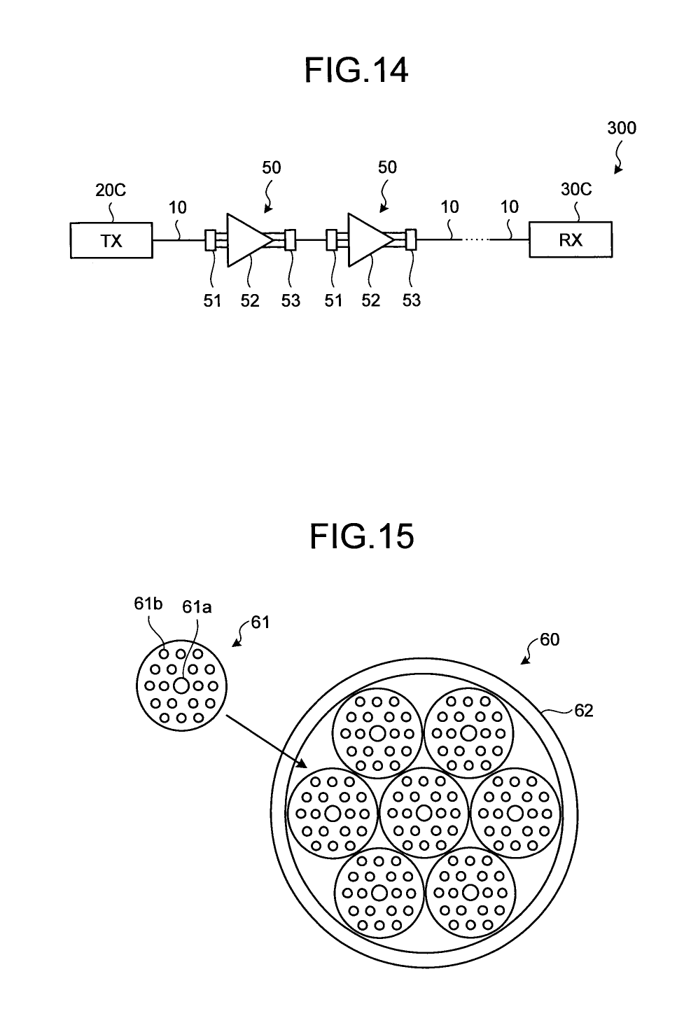

FIG. 14 is a block structural diagram of an optical transmission system according to a ninth embodiment. As illustrated in FIG. 14, an optical transmission system 300 has a configuration in which a plurality of multi-core optical fibers 10 and a plurality of multi-core optical amplifiers 50 are alternately connected between the transmission device 20C and the receiving device 30C illustrated in FIG. 4.

The multi-core optical amplifier 50 includes an optical connector 51, an optical amplification unit 52, and an optical connector 53. The optical amplification unit 52 is configured of an optical fiber amplifier such as a rare earth doped optical fiber amplifier or a Raman amplifier, for example. These optical amplifiers have three types of amplifying optical fibers that are able to amplify signal light beams of the S band, C band, and L band, respectively. The optical connector 51 is configured to cause the signal light beams transmitted through the multi-core optical fiber 10 to be input to the amplifying optical fibers for the respective bands of the optical amplification unit 52 for the S band, the C band, and the L band, respectively. The optical connector 53 is configured to cause the signal light beam of each band amplified by each optical fiber of the optical amplification unit 52 to be input to the corresponding core portion of the multi-core optical fiber 10 for each signal light beam. The amplifying optical fibers for the respective bands may be configured of single-core optical fibers each having a single core portion, or of a multi-core optical fiber, for example. In this case, as for the C band as an example: single-core amplifying optical fibers may be provided as many as the number of signal light beams of the C band to be amplified; the signal light beams of the C band to be amplified may be classified into a plurality of groups and single-core amplifying optical fibers may be provided as many as the number of these groups; or all of the signal light beams of the C band may be amplified by one single-core amplifying optical fiber. Further, a multi-core amplifying optical fiber having core portions as many as the number of the signal light beams of the C band to be amplified may be provided, or a multi-core amplifying optical fiber having core portions as many as the number of groups of the signal light beams of the C band to be amplified may be provided.

The optical transmission system 300 is also suitable for achieving longer distance optical transmission because the multi-core optical fibers 10 are cascading-connected by the multi-core optical amplifiers 50 serving as optical repeaters.

Next, a method of manufacturing the multi-core optical fiber 10B of the photonic band gap type illustrated in FIG. 7 is described. The multi-core optical fiber 10B may be manufactured using a known stack-and-draw method, by forming an optical fiber preform in which holes to become the core portions 11B to 17B, and holes for forming the band gap wavelength bands in the core portions 11B to 17B are formed, and drawing it while controlling its holey structure. Furthermore, its manufacturing load is further reduced if the multi-core optical fiber 10B is manufactured by a method described below.

FIG. 15 is a diagram illustrating an example of a method of manufacturing the multi-core optical fiber 10B of the photonic band gap type. In the method illustrated in FIG. 15, a glass preform 61 including a hole 61a to become any one of the core portions 11B to 17B and holes 61b for forming the band gap wavelength band in the core portion is formed by the stack-and-draw method. Seven glass preforms 61 that correspond to characteristics of the respective core portions 11B to 17B are prepared. Then a bundle of the glass preforms 61 are inserted into a glass tube 62 to form an optical fiber preform 60. A thickness of the glass preforms is chosen such that stacking into the glass tube 62 is possible. Then the multi-core optical fiber 10B is manufactured by drawing the optical fiber preform 60. According to this method, because not many glass tubes or glass bars for forming the holey structure need to be stacked at once, the manufacturing load is reduced further. When the optical fiber preform 60 is formed, gaps between the glass preforms 61 and the glass tube 62 are preferably filled with glass bars or that like for stabilizing the structure because the holey structure is then stabilized during the drawing. Further, the holes may be deformed into a desired shape by controlling pressure inside the holes during the drawing so as to improve characteristics of the multi-core optical fiber such as loss characteristics.

Although the multi-core optical fiber of the photonic band gap type is of the air-core type in which the core portions have the holey structure in the above-described embodiment, it may be of a solid-core type in which the core portions have the solid structure. In an optical fiber preform for manufacturing the multi-core optical fiber of the solid-core type, the portion to become the core portion in FIG. 15 is not holey, but has the solid structure.

Further, although the optical amplifier in the transmission device or the receiving device is provided for each transmitter or the receiver in the above-described embodiments, an optical amplifier may be used that amplifies altogether the signal light beams corresponding to the plurality of transmitters or receivers.

Further, although the number of core portions of the multi-core optical fiber is seven in the above-described embodiments, the present invention may also be applied to a known multi-core optical fiver having 19 core portions for example, not particularly being limited thereto, as long as the number is two or more.

Further, those configured by combining as appropriate any of the structural components of any of the respective embodiments are also included in the present invention. Furthermore, other embodiments, examples, and operation techniques made by persons skilled in the art based on the above-described embodiments are all included in the present invention.

According to an embodiment of the disclosure, good crosstalk characteristics are achieved by inputting signal light beams having different wavelengths from each another to core portions that are the most adjacent to each other in a multi-core optical fiber.

What is claimed is:

1. An optical transmission system comprising:
a multi-core optical fiber having a plurality of core portions, wherein
signal light beams having wavelengths different from each other are caused to be input to adjacent core portions of the plurality of core portions, the adjacent core portions being the most adjacent to each other in the multi-core optical fiber.

2. The optical transmission system according to claim 1, wherein wavelength division multiplexing signal light beams including the signal light beams are input to at least one of the plurality of core portions.

3. The optical transmission system according to claim 1, wherein wavelength division multiplexing signal light beams including the signal light beams having wavelengths different from each other are respectively input to the core portions, and the wavelength division multiplexing signal light beams are included in wavelength bands different from each other.

4. The optical transmission system according to claim 1, wherein, when channel numbers are allocated to signal channels composing wavelength division multiplexing signal light beams, the signal light beams having wavelengths different from each other are: a signal light beam of an odd-numbered channel; and a signal light beam of an even-numbered channel.

5. The optical transmission system according to claim 1, wherein the signal light beams having wavelengths different from each other are respectively included in wavelength bands different from each other.

6. The optical transmission system according to claim 1, wherein the plurality of core portions comprise a plurality of core portion groups each including at least one core portion having the same optical characteristic, and the signal light beams having wavelengths different from each other are respectively input to core portions belonging to different ones of the plurality of core portion groups.

7. The optical transmission system according to claim 6, wherein, when channel numbers are allocated in order of wavelength to signal channels composing wavelength division multiplexing signal light beams, the signal light beams having wavelengths different from each other have channel numbers adjacent to each other.

8. The optical transmission system according to claim 7, wherein the signal light beams having wavelengths different from each other are respectively included in wavelength bands different from each other.

9. The optical transmission system according to claim 1, wherein the multi-core optical fiber is of a solid type.

10. The optical transmission system according to claim 1, wherein the multi-core optical fiber is of a holey fiber type.

11. The optical transmission system according to claim 1, wherein the multi-core optical fiber is of a photonic band gap type.

12. A multi-core optical fiber, comprising:
a plurality of core portions; and
a plurality of holes arranged to form photonic band gaps of band gap wavelength bands different from each other for adjacent core portions adjacent to each other of the plurality of core portions.

13. The multi-core optical fiber according to claim 12, wherein the band gap wavelength bands for the adjacent core portions are respectively included in optical communications wavelength bands different from each other.

14. The multi-core optical fiber according to claim 12, wherein the plurality of core portions comprise a plurality of core portion groups each including at least one core portion having the same band gap wavelength band, and the plurality of core portion groups have band gap wavelength bands different from each other.

15. The multi-core optical fiber according to claim 12, wherein the plurality of core portions have a holey structure.

16. The multi-core optical fiber according to claim 12, wherein the plurality of core portions have a solid structure.

17. A method of manufacturing the multi-core optical fiber according to claim 12, the method comprising:
forming a plurality of glass preforms including portions to become the core portions and holes for forming the band gap wavelength bands in the core portions by a stack-and-draw method;
forming an optical fiber preform by bundling the plurality of glass preforms; and
drawing the optical fiber preform to manufacture the multi-core optical fiber.

18. A method of manufacturing the multi-core optical fiber according to claim 12, the method comprising:
forming an optical fiber preform including portions to become the plurality of core portions and holes for forming the band gap wavelength bands in the core portions by a stack-and-draw method; and
drawing the optical fiber preform to manufacture the multi-core optical fiber.
